(19) United States
(12) Patent Application Publication
(10) Pub. No.: US 2020/0044532 A1
(43) Pub. Date: Feb. 6, 2020

(54) LINEAR VIBRATION MOTOR

(71) Applicant: AAC Acoustic Technologies (Shenzhen) Co., Ltd., Shenzhen (CN)

(72) Inventor: Tao Zhang, Shenzhen (CN)

(21) Appl. No.: 16/526,970

(22) Filed: Jul. 30, 2019

(30) Foreign Application Priority Data
Aug. 3, 2018 (CN) 201821255498.6

(51) Int. Cl. H02K 33/12

(52) U.S. Cl. CPC H02K 33/12; B06B 1/045

(57) ABSTRACT

The present disclosure provides a linear vibration motor, including a base having an accommodating space, a vibration system accommodated in the accommodating space, an elastic member configured to fix and suspend the vibration system in the accommodating space, and a drive system fixed on the base and configured to drive the vibration system to vibrate in a direction perpendicular to a horizontal direction. The drive system includes a coil fixed on the base, and a winding plane of the coil is perpendicular to a vibration direction of the vibration system. The vibration system includes a magnetic steel unit fixed on the elastic member and disposed around the drive system. An angle formed between a magnetization direction of the magnetic steel unit and a vibration direction of the magnetic steel unit is greater than 0 degrees and less than 90 degrees.

### TECHNICAL FIELD

The present disclosure relates to a motor, and in particular, to a linear vibration motor applied to the field of mobile electronic products.

### BACKGROUND

With the development of electronic technology, portable consumer electronic products such as mobile phones, handheld game consoles, navigation apparatuses or handheld multimedia entertainment devices become increasingly popular among people. Linear vibration motors are usually used in these electronic products to provide system feedbacks such as call alerts, message alerts, and navigation alerts of mobile phones and vibration feedbacks of game consoles. Such wide application causes vibration motors to have high performance and long service life.

A linear vibration motor in related technologies includes a base having an accommodating space, a vibration system located in the accommodating space, an elastic member configured to fix and suspend the vibration system in the accommodating space, and a drive system fixed on the base. The drive system includes a coil. The vibration system includes magnetic steel. Electromagnetic fields generated by the coil and the magnetic steel interact to drive the vibration system to make a reciprocal linear movement to generate vibration.

However, in a structure in which the linear vibration motor in related technologies vibrates in a Z-axis direction, a magnetization direction of the magnetic steel is parallel to a vibration direction of the magnetic steel. That is, the magnetic steel vertically magnetizes in a direction perpendicular to a horizontal direction. In this case, because a structure formed by permeability magnetic material is usually disposed at a bottom portion of the magnetic steel to conduct magnetism and magnetic fields do not have priority, after reaching the bottom portion, a magnetic line is equally divided in a direction parallel to a horizontal direction to pass through towards an inner side and an outer side of the bottom portion. A voice coil is only located on an inner side of the magnetic steel, at least half of the magnetic fields are not used. That is, the utilization of the magnetic fields is low, a force factor BL is small, and the vibration performance of the linear vibration motor is affected.

Therefore, it is necessary to provide a new linear vibration motor to resolve the foregoing problem.

### BRIEF DESCRIPTION OF THE DRAWINGS

FIG. 1 is a schematic structural perspective view of a linear vibration motor according to the present disclosure;

FIG. 2 is a schematic exploded view of a linear vibration motor according to the present disclosure;

FIG. 3 is a schematic sectional view along a line A-A in FIG. 1; and

FIG. 4 is a partial schematic structural view of another implementation of a linear vibration motor according to the present disclosure.

### DETAILED DESCRIPTION

The present disclosure is further described below with reference to the accompanying drawings and implementations.

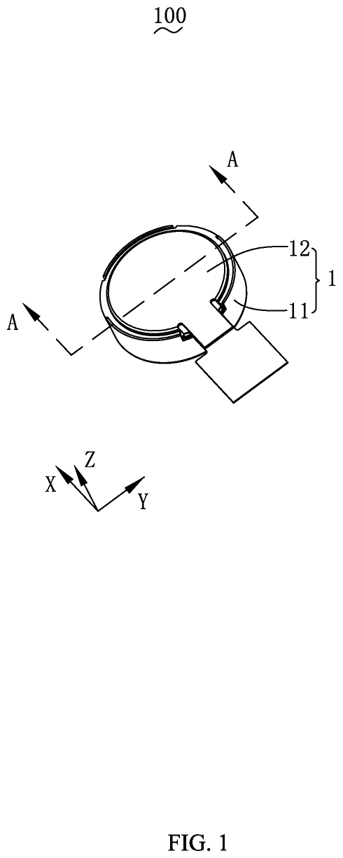

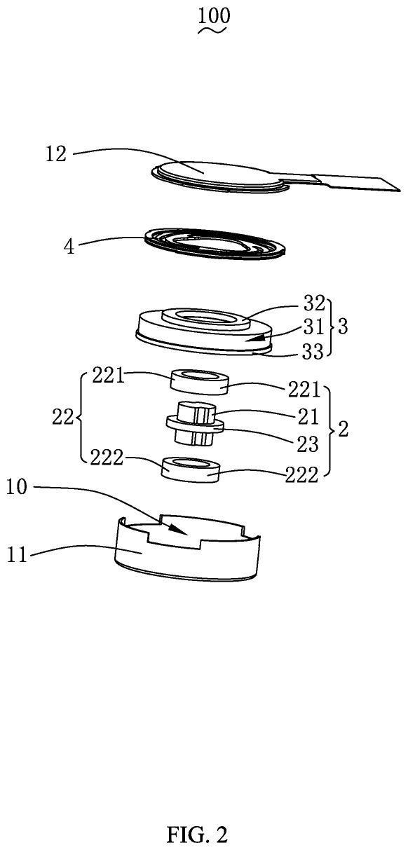

Referring to FIG. 1 to FIG. 3 together, the present disclosure provides a linear vibration motor 100, including a base 1, a drive system 2, a vibration system 3, and an elastic member 4.

The base 1 includes a seat 11 and a cover plate 12 covering the seat 11. The seat 11 and the cover plate 12 enclose an accommodating space 10 together. The base 1 may be an integral structure or may be a separate structure.

The drive system 2 is fixed on the base 1, and is configured to drive the vibration system 3 to vibrate in a direction perpendicular to a horizontal direction, that is, perpendicular to a plane formed of X and Y axes in FIG. 1, so as to generate vibration in a Z-axis direction.

In this implementation, the drive system 2 includes an iron core 21 and a coil 22 fixedly sleeved over the iron core 21. Specifically, the coil 22 includes a first coil 221 and a second coil 222. The first coil 221 and the second coil 222 are respectively fixedly sleeved over the iron core 21 and are located between the iron core 21 and the vibration system 3.

The iron core 21 is fixed on the base 1, for example, fixed on the cover plate 12. The iron core 21 is disposed to improve a magnetic conduction effect of magnetic fields to increase a driving force of the drive system 2, so that the vibration system 3 has a better vibration effect.

A plane in which the first coil 221 and the second coil 222 are located is perpendicular to a vibration direction of the vibration system 3.

It should be noted that the first coil 221 and the second coil 222 may be disposed separately or abutted against each other in an insulated manner. Moreover, the first coil 221 and the second coil 222 may be two independent coils or a two-coil structure formed by winding a same coil wire. Both cases are feasible.

In this implementation, the first coil 221 and the second coil 222 are disposed separately from each other, and a separation plate 23 is sandwiched between the first coil 221 and the second coil 222. The separation plate 23 is fixedly sleeved over the iron core 21. Certainly, the separation plate 23 and the iron core 21 may have an integral structure. Specifically, current directions of the first coil 221 and the second coil 222 are opposite.

The vibration system 3 includes a magnetic steel unit 31 fixed on the elastic member 4 and a first pole core 32 and a second pole core 33 respectively fixed on two opposite sides of the magnetic steel unit 31 in the vibration direction of the vibration system 3, where the first pole core 32 is near the cover plate 12.

The magnetic steel unit 31 surrounds both the first coil 221 and the second coil 222, is disposed separately from the first coil and second coil, and may have an annular structure. An orthogonal projection of the magnetic steel unit 31 in a direction towards the drive system 2 at least partially falls in the first coil 221 and the second coil 222, respectively. The structure is disposed to enable horizontally divided magnetism on an upper side and a lower side of the magnetic steel unit 31 to respectively pass through the first coil 221 and the second coil 222 to provide a Lorentz force, and to make the utilization of the magnetic fields high, so that a force factor BL is maximized, thereby effectively improving the vibration performance of the linear vibration motor 100.

After passing through the first coil 221, the magnetic fields pass the iron core 21, and leave the iron core 21 to pass through the second coil 222 again. Because the current directions of the first coil 221 and the second coil 222 are opposite, Lorentz forces generated by the first coil 221 and the second coil 222 have the same direction, thereby significantly improving the vibration performance of the linear vibration motor 100.

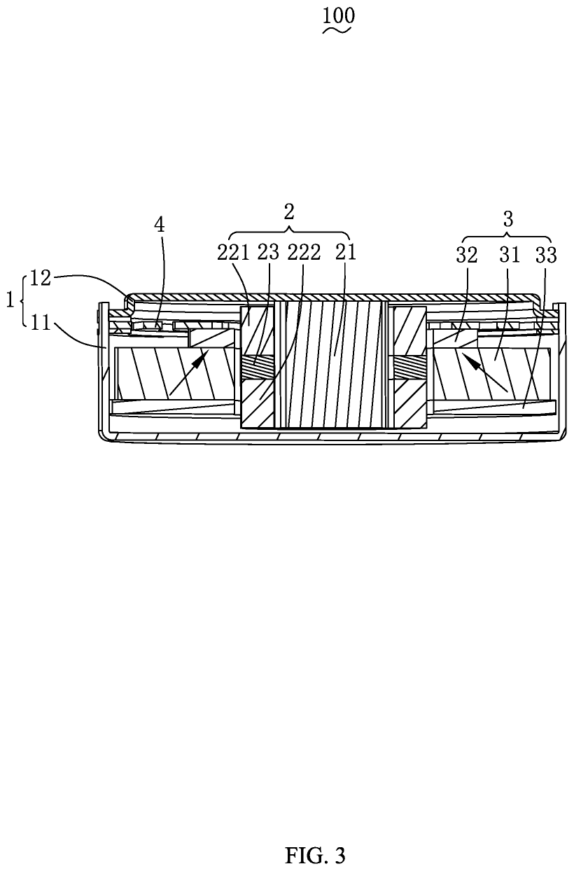

In this implementation, an angle formed between a magnetization direction of the magnetic steel unit 31 and a vibration direction (a Z-axis direction in FIG. 1) of the magnetic steel unit 31 is greater than 0 degrees and less than 90 degrees, that is, a magnetic direction is not parallel to the vibration direction. The objective of disposing the structure is to effectively increase a proportion of horizontal magnetic fields guided towards the drive system, so that the utilization of the magnetic fields is effectively improved to increase a force factor BL to increase a Lorentz force, thereby effectively improving the vibration performance of the linear vibration motor 100. The magnetization direction of the magnetic steel unit 31 is shown by the arrow in FIG. 3.

Specifically, the magnetization direction of the magnetic steel unit 31 is set from a side, far away from the cover plate 12, of the magnetic steel unit 31 to the other opposite side of the magnetic steel unit 31 in a direction towards the coil 22.

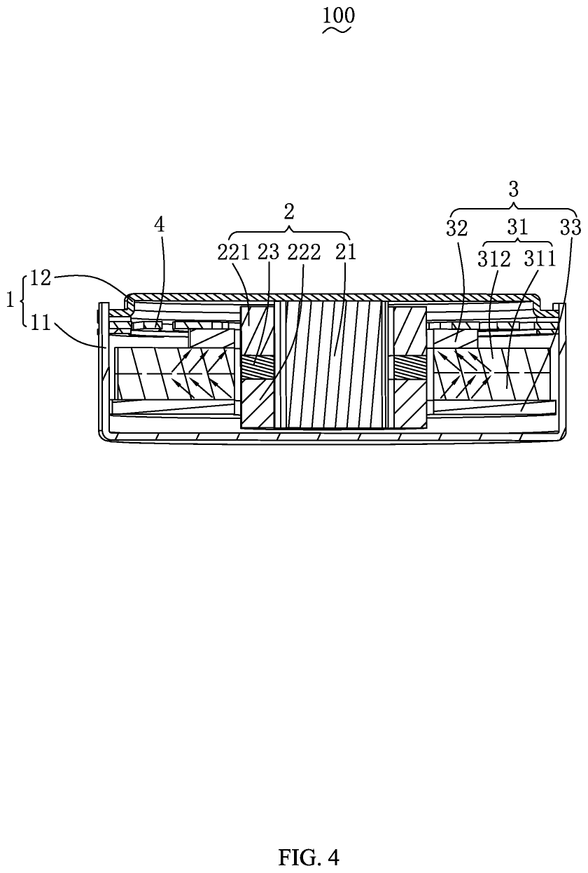

Certainly, the magnetization direction of the magnetic steel unit 31 is not limited thereto. The magnetic steel unit 31 further has another implementation structure. Referring to FIG. 4, the magnetic steel unit 31 includes a first part 311 and a second part 312 that are stacked together. A magnetization direction of the first part 311 is set from a side, far away from the second part 312, of the first part 311 to the other opposite side of the first part 311 in a direction away from the coil 22. A magnetization direction of the second part 312 is set from a side, near the first part 311, of the second part 312 to the other opposite side of the second part 312 in a direction towards the coil 22. This is also feasible. The magnetization direction of the magnetic steel unit 31 is shown by the arrow in FIG. 4.

It should be noted that the first part 311 and the second part 312 may have an integral structure or may have a separate structure. Different magnetization directions of the two parts are different in the case of an integral structure, or two magnetic steel structures with different magnetization directions forming a stack in the case of a separate structure. The same principle is used for both cases.

The first pole core 32 and the second pole core 33 are respectively stacked in the two opposite sides of the magnetic steel unit 31 in the vibration direction of the vibration system 3, and are configured to conduct magnetism, thereby reducing a magnetic field loss of the magnetic steel unit 31.

The elastic member 4 fixes and suspends the vibration system 3 in the accommodating space 10, to facilitate the vibration of the vibration system 3. Specifically, the elastic member 4 is fixed on the first pole core 32, thereby implementing suspension of the vibration system 3.

In this implementation, the elastic member 4 has an annular structure, and is fixed on a side, near the cover plate 12, of the seat 11.

Compared with related technologies, in the vibration system of the linear vibration motor of the present disclosure, the angle formed between the magnetization direction of the magnetic steel unit and the vibration direction of the magnetic steel unit is greater than 0 degrees and less than 90 degrees, that is, the magnetization direction is not parallel to the vibration direction. The structure is disposed to effectively increase a proportion of horizontal magnetic fields guided towards the drive system, so that the utilization of the magnetic fields is effectively improved to increase a force factor BL to increase a Lorentz force, thereby effectively improving the vibration performance of the linear vibration motor.

The foregoing descriptions are merely preferred embodiments of the present disclosure but are not intended to limit the patent scope of the present disclosure. Any equivalent modifications made to the structures or processes based on the content of the specification and the accompanying drawings of the present disclosure, or directly or indirectly use the content of the specification and the accompanying drawings of the present disclosure in other relevant technical fields shall also fall within the patent protection scope of the present disclosure.

What is claimed is:

1. A linear vibration motor, comprising a base having an accommodating space, a vibration system accommodated in the accommodating space, an elastic member configured to fix and suspend the vibration system in the accommodating space, and a drive system fixed on the base and configured to drive the vibration system to vibrate in a direction perpendicular to a horizontal direction, wherein the drive system comprises a coil fixed on the base, a winding plane of the coil is perpendicular to a vibration direction of the vibration system, the vibration system comprises a magnetic steel unit fixed on the elastic member and disposed around the drive system, and an angle formed between a magnetization direction of the magnetic steel unit and a vibration direction of the magnetic steel unit is greater than 0 degrees and less than 90 degrees.

2. The linear vibration motor according to claim 1, wherein the coil comprises a first coil and a second coil fixed on the base and arranged in the vibration direction, the magnetic steel unit surrounds both the first coil and the second coil and is disposed separately from the first coil and second coil, and an orthogonal projection of the magnetic steel unit in a direction towards the drive system at least partially falls in the first coil and the second coil, respectively.

3. The linear vibration motor according to claim 1, wherein the magnetization direction of the magnetic steel unit is set from a side of the magnetic steel unit to the other opposite side of the magnetic steel unit in a direction towards the coil.

4. The linear vibration motor according to claim 1, wherein the magnetic steel unit comprises a first part and a second part that are stacked together in the vibration direction, a magnetization direction of the first part is set from a side, far away from the second part, of the first part to the other opposite side of the first part in a direction away from the coil, and a magnetization direction of the second part is set from a side, near the first part, of the second part to the other opposite side of the second part in a direction towards the coil.

5. The linear vibration motor according to claim 2, wherein the drive system further comprises an iron core fixed on the base, and the first coil and the second coil are fixedly sleeved over the iron core and are located between the iron core and the magnetic steel unit.

6. The linear vibration motor according to claim 5, wherein the drive system further comprises a separation plate fixedly sleeved over the iron core, and the separation plate is sandwiched between the first coil and the second coil.

7. The linear vibration motor according to claim 1, wherein the vibration system further comprises a first pole core and a second pole core respectively fixed on two opposite sides of the magnetic steel unit in the vibration direction of the vibration system.

8. The linear vibration motor according to claim 7, wherein the elastic member is fixed on the first pole core.
